(19) United States
(12) Patent Application Publication
(10) Pub. No.: US 2012/0070568 A1
(43) Pub. Date: Mar. 22, 2012

(54) COLOR GOLF BALL

(76) Inventor: Matthew F. Hogge, Plymouth, MA (US)

(21) Appl. No.: 13/253,226

(22) Filed: Oct. 5, 2011

Related U.S. Application Data
(63) Continuation of application No. 13/253,187, filed on Oct. 5, 2011.
Application No. 13/253,187 is a continuation-in-part of application No. 12/972,709, filed on Dec. 20, 2010.
Application No. 12/972,709 is a continuation-in-part of application No. 12/359,619, filed on Jan. 26, 2009.
Application No. 12/359,619 is a continuation-in-part of application No. 11/707,493, filed on Feb. 16, 2007, now Pat. No. 7,722,483.

(51) Int. Cl. B05D 7/00

(52) U.S. Cl. 427/157; 427/205

(57) ABSTRACT

A method of making a golf ball comprising providing a core, a cover layer and optionally an intermediate layer, wherein at least one of the core, cover layer and intermediate layer comprises or is surface-coated with a color effect providing pigment comprising at least one of: (1) calcium aluminum borosilicate coated with a metal oxide; (2) silicon dioxide platelets coated with metal oxide; and (3) an iron oxide pigment substrate coated with a metal oxide; optionally forming the intermediate layer about the core; and forming the cover about the intermediate layer or the core to complete the golf ball. The color effect providing pigment may have a particle size of from about 5 μm to about 200 μm.

### CROSS-REFERENCE TO RELATED APPLICATIONS

This application is a continuation of U.S. patent application Ser. No. 13/253,187, filed Oct. 5, 2011, which is a continuation-in-part of co-pending U.S. patent application Ser. No. 12/972,709, filed Dec. 20, 2010, which is a continuation-in-part of co-pending U.S. patent application Ser. No. 12/359,619, filed Jan. 26, 2009, now U.S. Publ. No. 20090137343, which is a continuation-in-part of U.S. patent application Ser. No. 11/707,493, filed on Feb. 16, 2007, now U.S. Pat. No. 7,722,483, each of which is incorporated by reference herein in its entirety.

### FIELD OF THE INVENTION

The invention relates generally to golf balls incorporating color effects pigments, dyes and/or tints in at least one of the core, an intermediate layer, inner cover layer, outer cover layer and a coating.

### BACKGROUND OF THE INVENTION

Golf balls, whether of solid or wound construction, generally include a core and a cover. It is known in the art to modify the properties of a conventional solid ball by altering the typical single layer core and single cover layer construction to provide a ball having at least one mantle layer disposed between the cover and the core. The core may be solid or liquid-filled, and may be formed of a single layer or one or more layers. Covers, in addition to cores, may also be formed of one or more layers. These multi-layer cores and covers are sometimes known as “dual core” and “dual cover” golf balls, respectively. Additionally, many golf balls contain one or more intermediate layers that can be of solid construction or may be formed of a tensioned elastomeric winding, which are referred to as wound balls. One piece golf balls are even available. The difference in play characteristics resulting from these different types of constructions can be quite significant. The playing characteristics of multi-layer balls, such as spin and compression, can be tailored by varying the properties of one or more of these intermediate and/or cover layers.

Moreover, color and color effects in a golf ball, being dominant visual features, are also capable of positively contributing to and enhancing a golfer's game by improving the player's ability to focus on the golf ball when swinging a club and striking the ball. It is desirable that a golfer's eye be drawn to the ball easily. By keeping an eye on the ball, the golfer is able to remain focused on the immediate task at hand of maintaining hand-eye coordination and producing great balance during swing with consistent spine angle in order for the club face to strike the golf ball with just the right force, depending on the chosen club and desired distance. In this way, a golf ball's unique visual appearance can influence and improve the golfer's physical performance substantially.

Meanwhile, golf balls that are attractive and exude superior quality will also boost a golfer's confidence and morale, thereby motivating, inspiring and ultimately peaking performance on the green. Additionally, visually superior golf balls may be spotted and located more easily on the golf course, thereby reducing a player's stress level which naturally translates into improved scores. Accordingly, golf ball manufacturers desire to incorporate color shades and color effects in golf balls which will beneficially impact and improve both the physical and emotional/psychological aspects of a golfer's game.

Toward this end, manufacturers have incorporated color effects such as optically variable pigments in golf balls. For example, golf balls heretofore have incorporated metal-oxide coated mica based pigments, metal-oxide coated aluminum oxide platelets and metal-oxide coated silica platelets involving interference, reflection and absorption phenomena. But there remains a need for a golf ball whose colors and color effects appear equally elegant, attractive and captivating to the human eye under the wide range of different lighting and/or weather conditions which occur on the green. The present invention addresses and solves this problem.

### SUMMARY OF THE INVENTION

The invention relates to a golf ball incorporating color effects which provide a consistent, dominant, vibrant, appealing and focusing visual appearance on the green through a unique combination of interference and reflection between the color effect's components under visible light. Specifically, the golf ball of the invention comprises a core of at least one layer, a cover of at least one layer and optionally at least one intermediate layer disposed between the core and the cover, wherein at least one of the core, cover and intermediate layer comprises a color effect providing pigment comprising at least one of: (1) calcium aluminum borosilicate coated with a metal oxide; (2) silicon dioxide platelets coated with metal oxide; and (3) an iron oxide pigment substrate coated with a metal oxide. A golf ball incorporating such a color effect maintains an equally attractive and elegant appearance to the human eye no matter what time of day a game is played or what the weather conditions may be.

In another embodiment, the golf ball comprises a core of at least one layer, a cover comprising an inner cover layer and an outer cover layer and optionally at least one intermediate layer disposed between the core and the cover. The inner cover layer may comprise or be surface-coated with an effect or luster pigment which contributes to the color appearance of the ball and comprises at least one of: (1) calcium aluminum borosilicate coated with a metal oxide; (2) silicon dioxide platelets coated with metal oxide; and (3) an iron oxide pigment substrate coated with a metal oxide. In this embodiment, the outer cover layer is at least partially transparent.

In yet another embodiment, the golf ball of the invention comprises a core of at least one layer; a cover of at least one layer; optionally at least one intermediate layer disposed between the core and the cover; and a paint layer on a surface of at least one of the core, cover and intermediate layer. The paint layer comprises a color effect providing pigment comprising at least one of: (1) calcium aluminum borosilicate coated with a metal oxide; (2) silicon dioxide platelets coated with metal oxide; and (3) an iron oxide pigment substrate coated with a metal oxide.

In one embodiment, the core and/or core surface comprises the color effect providing pigment. In another embodiment, an intermediate layer and/or intermediate layer surface comprises the color effect providing pigment and the cover is at least partially translucent or transparent. In yet another embodiment, the cover and/or cover surface comprises the color effect providing pigment. Any or all of golf ball core, intermediate layer and cover/cover layer may comprise or be treated with and comprise the color effect providing pigment or even be coated with the color effect providing pigment.

A golf ball of the invention includes a color effect providing pigment in wherein a first color effect is coated on a particular substrate to produce a second color effect that differs from the first color effect. For example, a pigment substrate having first and second substantially parallel and planar surfaces may be coated with an effects pigment. When the color effect providing pigment is incorporated in or on the inventive golf ball's substantially spherical cover surface or cover surface coating, an optimized dominant visual presence on the green is achieved under visible light (between about 380 nm and about 770 nm or between about 400 nm and about 700 nm).

A golf ball of the invention may incorporate metal oxide coated iron platelets such as Variocrom® Magic Purple L 5520, available from BASF. Such effect pigments offer “angle-dependent color plays” and “pronounced color travel ranging from purple via orange to a shade of gold”. See BASF literature and brochures. A golf ball of the invention may also include metal oxide coated calcium borosilicate such as Mirival® or Xirona®, available from Merck. Mirival® “produces glittering highlights, outstanding sparkle, high brilliance and gloss, very high transparency and a unique rainbow effect”. See Merck literature and brochures. Xirona “gives a special travel effect from red to copper to gold, which changes depending on the viewing angel”. See Merck literature and brochures. The color is “shiny gold when viewed from a flat angle and changes to clear, fiery red as the viewing angle increases”. See Merck literature and brochures. It may create a glitter effect. See Merck literature and brochures. Silicon dioxide platelets coated with metal oxide such as Merck's Colorstream® create “color-travel iredescent interference effects” and “unique multi-colored effects” which “can be seen well in subdued lighting conditions” and “create a soft flowing transition from one color to the next”. See Merck Colorstream® literature and brochures

Golf balls of the invention display a particularly dramatic and vibrant appearance due to a unique interplay between the color effect's components under visible light. Interference and reflection create an unprecedented and superior appearance for the generally spherical golf ball notwithstanding the particular lighting conditions on the golf course.

In a golf ball of the invention, the color effect providing pigment described above may have particle sizes of from about 5 μm to about 200 μm, or from about 10 μm to about 100 μm, or from about 5 μm to about 50 μm, or from about 5 μm to about 20 μm, or from about 10 μm to about 50 μm, or from about 10 μm to about 20 μm, or from about 20 μm to about 200 μm, or from about 15 μm to about 20 μm, or from about 5 μm to about 11 μm.

Suitable metal oxides include, without limitation, silicon dioxide, aluminum oxide, titanium dioxide, zirconium dioxide, tin dioxide, zinc oxide, iron oxide as well as any other metal oxides commonly known.

The color effect providing pigment may be incorporated in a layer or be a coating/painting on a golf ball component/layer or even comprise a printing ink composition selectively applied on the golf ball to convey a logo or other visible design or message, etc.

The color effect pigment may be incorporated in the core only, in intermediate/mantle layer only, in the cover only, or in any or all thereof.

Where the color effect pigment is incorporated in the golf ball as a coating, the coating may be applied on one or more of the core intermediate/mantle layer and cover. Also, the golf ball may only include one or more of the disclosed color effect providing pigments.

In the present invention, a golf ball incorporating these color effects display colors which are identifiable under at least one of several known color systems. Some of the colors displayed may be identifiable in the CIELAB (1976) color space—wherein color is defined under only one lighting condition or illuminant, namely D65.

Alternatively, many color effects displayed by such golf balls of the invention may be identifiable under color systems such as the CIECAM color system which consider, address or account for how changing stimuli on the green will affect a golfer's visual perception of color. This color appearance model takes into account the effect of varying viewing conditions on the human eye's perception of golf ball color shades and assesses which colors a golfers will visually perceive most favorably under a wide range of golf course viewing conditions. See FIG. 1. A golfer's perception of some color shades will vary considerably with changed viewing conditions. For example, the time of day that a golf game is played may vary the viewing conditions as it is usually much brighter during a game played in the midday sun than one played at dusk. Another factor which may affect viewing conditions is weather—on a sunny day, the human golfer's eye will perceive some golf ball color shades differently than on an overcast or even rainy day. Meanwhile, the color of the background against which the golf ball lies (e.g., teeing ground versus on fairway, rough or hazard) will change how the golfer's eye perceives some golf ball color shades.

The golf ball manufacturer can accurately predict how the average golfer will perceive a specific overall golf ball color shade under different viewing conditions by incorporating color effects which fall within the CIE CIECAM color appearance model in golf balls of the invention, since this system was developed based on human perception. In this way, it becomes possible for a golf ball manufacturer to identify and incorporate into a golf ball only those color effects shades which are most likely to produce the least variance in a golfer's perception of color in response to the expected changes to stimuli on the golf course and therefore be most appealing to the golfer's eye under a variety of viewing circumstances.

In one embodiment, the layer comprising the color effect providing pigment further comprises a thermoplastic material. In another embodiment, the layer comprising the color effect providing pigment further comprises a thermoset material. In yet another embodiment, the layer comprising the color effect providing pigment further comprises an ionomer material. In still another embodiment, the layer comprising the color effect providing pigment further comprises a highly neutralized polymer material. The layer comprising the color effect providing pigment may comprise any of these elements, alone or in combination.

In one embodiment the golf ball further comprises at least one of a pigment, dye and tint that is fluorescent. The the pigment, dye or tint may be inorganic or organic.

The cover may further comprise particulate material selected from the group comprising metal flake, iridescent glitter, metalized film and colored polyester foil. The cover may further comprise a material which is at least partially transparent, translucent or pearlescent. The cover may also incorporate traditional effect pigments. At least one of the cover and the intermediate layer may further comprise a material which is at least partially transparent, translucent or pearlescent.

The layer comprising the color effect providing pigment may have a Mooney viscosity of from about 30 to about 130.

The overall golf ball may have a compression of from about 25 to about 110. In one embodiment, the overall golf ball has a compression of from about 25 to about 110. In another embodiment, the overall golf ball has a compression of from about 35 to about 100. In yet another embodiment, the overall golf ball has a compression of from about 45 to about 95. In still another embodiment, the compression may be from about 55 to about 85, or from about 65 to about 75. Meanwhile, the compression may also be from about 50 to about 110, or from about 60 to about 100, or from about 70 to about 90, or even from about 80 to about 110.

Generally, the overall golf ball coefficient of restitution (COR) is at least about 0.780. In another embodiment, the overall golf ball COR is at least about 0.788. In yet another embodiment, the overall golf ball COR is at least about 0.791. In still another embodiment, the overall golf ball COR is at least about 0.794. Also, the overall golf ball COR may be at least about 0.797. The overall golf ball COR may even be at least about 0.800, or at least about 0.803, or at least about 0.812.

The moment of inertia for a golf ball of the invention may be from about 0.410 oz-in² to about 0.470 oz-in². The moment of inertia for a one piece ball that is 1.62 ounces and 1.68 inches in diameter may be approximately 0.4572 oz-in², which is the baseline moment of inertia value.

In one embodiment, the layer comprising the color effect providing pigment has a moisture vapor transmission rate of from about 0.45 grams mm/m² day to about 1.5 grams·mm/m² day. In another embodiment, the layer comprising the color effect providing pigment has a moisture vapor transmission rate of about 0.95 grams mm/m² day or greater.

The invention also relates to a method of making the inventive golf balls. In one embodiment, the method of making the golf ball of the invention comprises: providing a core, a cover layer and optionally an intermediate layer, wherein at least one of the core, cover layer and intermediate layer comprises or is surface-coated with a color effect providing pigment comprising at least one of: (1) calcium aluminum borosilicate coated with a metal oxide; (2) silicon dioxide platelets coated with metal oxide; and (3) an iron oxide pigment substrate coated with a metal oxide; optionally forming the intermediate layer about the core; and forming the cover either about the intermediate layer or the core to complete the golf ball.

In another embodiment, the method of making a golf ball of the invention comprises: providing a core of at least one layer; providing a cover comprising an inner cover layer that either comprises or is surface coated and an outer cover layer; optionally providing at least one intermediate layer; wherein the inner cover layer either comprises or is surface coated with an effect or luster pigment which contributes to the color appearance of the ball and the outer cover layer is at least partially transparent; said effect or luster pigment comprising at least one of: (1) calcium aluminum borosilicate coated with a metal oxide; (2) silicon dioxide platelets coated with metal oxide; and (3) an iron oxide pigment substrate coated with a metal oxide; forming the inner cover layer about the core; and forming the outer cover layer about the inner cover layer to complete the golf ball.

In yet another embodiment, the method of making a golf ball of the invention comprises: providing a core of at least one layer, a cover of at least one layer, and optionally at least one intermediate layer; wherein at least one of the core, intermediate layer and cover is surface-painted with a color effect providing pigment comprising at least one of: (1) calcium aluminum borosilicate coated with a metal oxide; (2) silicon dioxide platelets coated with metal oxide; and (3) an iron oxide pigment substrate coated with a metal oxide; forming the intermediate layer about the core; and forming the cover about the intermediate layer to complete the golf ball.

In still another embodiment, the method of making a golf ball of the invention comprises: providing a core of at least one layer, a cover of at least one layer, and optionally at least one intermediate layer; surface painting at least one of the core, intermediate layer and cover with a color effect providing pigment comprising at least one of: (1) calcium aluminum borosilicate coated with a metal oxide; (2) silicon dioxide platelets coated with metal oxide; and (3) an iron oxide pigment substrate coated with a metal oxide; forming the intermediate layer about the core; and forming the cover about the intermediate layer to complete the golf ball.

Herein, the term “pigment” refers to any vehicle or means for contributing color and/or color effects to the golf ball.

### BRIEF DESCRIPTION OF THE DRAWINGS

FIG. 1 depicts a CIECAM hue circle as described herein.

### DETAILED DESCRIPTION

The present invention is directed to a golf ball comprising at least a core or a multi-piece core and a cover. The cover may comprise a translucent or transparent material that can be cast, injection molded, compression molded or reaction injection molded over a golf ball precursor or subassembly. Additionally, the cover comprises a plurality of dimples on its surface. The golf ball may also comprise an intermediate layer between the core and the cover. As taught in parent U.S. patent application Ser. No. 11/707,493 (published as US 2007/0149323), which has been incorporated by reference in entirety, the cover may comprise a substantially optically transparent or translucent material, so that the intermediate layer or core contributes to the color characteristics of the ball. The intermediate layer or core may be white, transparent or translucent, colored, or may have a multi-colored pattern. The intermediate layer may be opaque, transparent or translucent, or be white or comprise one or more colors. The cover may be translucent and may comprise an amount of pigment or dye, creating a colored but translucent cover under which the intermediate or outer core layer is visible. In this embodiment, the intermediate layer, which can be an outer core layer, may be colored or may comprise a pattern that is visible through the translucent outer cover. The intermediate or outer core layer may also be printed with indicia or other markings that may be viewed through the clear or translucent cover. The cover may also comprise an amount of reflective particulates to create a pearlescent or sparkle effect.

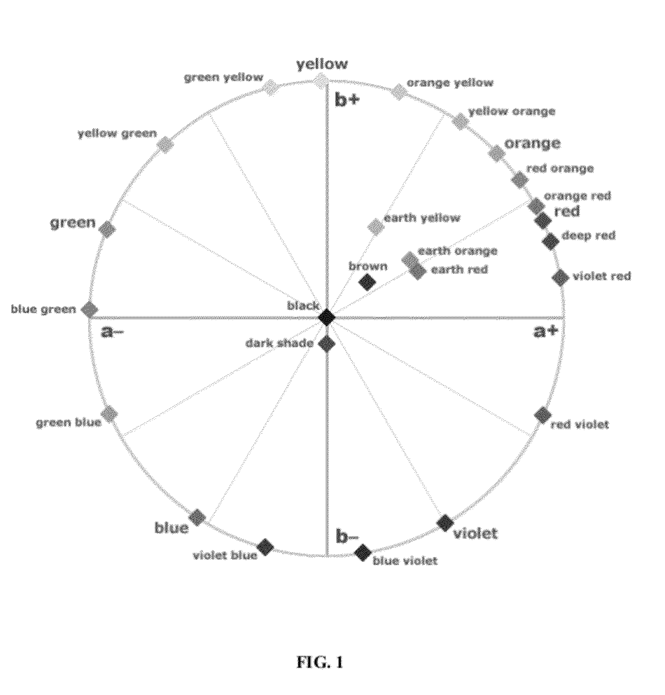

As previously stated herein, in one embodiment, the golf ball of the invention may have the overall appearance of at least one color within the CIECAM color model. Under the CIECAM model, J represents the lightness of a color and varies from 0 (or black) to 100 (or white). C or Chroma represents the intensity of the color, which may range from 0 (or neutral) to 81-95 or greater. The color being very intense to supersaturated. The diagram set forth in FIG. 1 represents the CIECAM hue circle and displays the hue angle for each color beginning at O° (a+) and moving counterclockwise around the CIECAM hue circle. For example, in the CIECAM hue circle of FIG. 1, “violet red” appears at approximately 12° on the wheel below.

On the CIECAM hue circle of FIG. 1, measurements from center(or black) to each of a+, a− and b+ or b− range from 0-100 horizontally and vertically, respectively. Accordingly, for example, the a, b values for “violet red” located in the hue wheel below at about hue angle 12° would be about a+=about 80 and b+=about 80. The hue circle of FIG. 1 is as presented at www.handprint.com© Bruce MacEvoy. Bruce MacEvoy measured and plotted the relationship of watercolor pigments on the CIECAM a_{c}b_{c} chroma based hue plane.

Herein, the term “color” constitutes the color of the overall finished golf ball as perceived by the golfer. Thus, in a golf ball of the invention, the intermediate layer and/or cover layer may each contribute to the final overall color appearance. For example, the intermediate layer may contribute a red color and the cover layer may contribute a blue color to form a golf ball which a golfer perceives as a violet color golf ball as defined within the CIECAM color model. Alternatively, the intermediate layer may contribute a blue color and the cover layer may contribute a red color to form a golf ball which a golfer perceives as a purple golf ball as defined within the CIECAM color model within the parameter disclosed herein. In a different embodiment, the intermediate layer may contributes a shade 1 violet and the cover layer may contribute a shade 2 violet to form a golf ball which a golfer perceives as a shade 3 violet as defined within the CIECAM color model parameters disclosed herein. Meanwhile, either the intermediate layer or cover layer may solely contribute a violet color or pink color to the final overall golf ball color appearance. And the overall color of a golf ball of the invention may simultaneously appear to be several colors depending on the viewing angle and the lighting conditions for example.

In one embodiment, present invention is directed to a golf ball comprising color shades which the golfer will perceive most favorably irrespective of changed viewing conditions. The golf ball of the invention incorporates color shades into a golf ball according to a color model which accounts for/considers a human's varied perception of color shades according to certain expected changes to the stimuli, such as the weather changing from sunny to cloudy, or the golfer playing at different times of day, or the golf ball being struck on different colored playing surfaces.

The CIECAM color appearance model which developed based on human perception and permits the golf ball manufacturer to accurately predict how the average golfer will perceive a specific golf ball color shade under different conditions. In this way, it becomes possible for the golf ball manufacturer to identify and incorporate into a golf ball only those color shades which remain most visually desirable to the golfer under a wide range of changed viewing conditions as well as are most likely to produce the least variance in a golfer's perception of color in response to the expected changes to stimuli on the golf course.

The golf ball of the invention incorporates colors taking into account the tristimulus values (X, Y and Z) of the stimulus, its background, its surround, the adapting stimulus, the luminance level, and other factors such as cognitive discounting of the luminant. The model includes correlates for perceptual attributes including brightness, lightness, colorfulness, chroma, saturation and hue.

Meanwhile, golf balls of the invention may also have the overall color appearance of a color within the CIE LAB color model or any other color model known in the golf ball art, as different effects may be achieved by choosing one color model over another, depending on the overall impression which the golf ball manufacturer wishes to convey on the green.

Golf balls made in accordance with this invention can be of any size, although the USGA requires that golf balls used in competition have a diameter of at least 1.68 inches and a weight of no greater than 1.62 ounces. For play outside of USGA competition, the golf balls can have smaller diameters and be heavier.

The core may be a wound core, which is visible through the clear or translucent cover. The uneven surface of the wound core creates a unique visual effect, as the crevices and ledges created by the wound elastomeric material create shadows visible through the clear or translucent cover. An intermediate layer may be disposed around the wound core. In this instance, the intermediate layer is visible through the clear or translucent cover and may be white, colored, or comprise multiple colors as disclosed herein in various patterns.

The cores in golf balls manufactured by the process of this invention may be solid, semi-solid, hollow, fluid-filled, or powder-filled. Typically, the cores are solid and made from rubber compositions containing at least a base rubber, free-radical initiator agent, cross-linking co-agent, and fillers. Golf balls having various constructions may be made in accordance with this invention. For example, golf balls having three-piece, four-piece, and five-piece constructions with dual or three-layered cores and cover materials may be made The term, “layer” as used herein means generally any spherical portion of the golf ball. More particularly, in one version, a three-piece golf ball comprising a core and a “dual-cover” is made. In another version, a four-piece golf ball comprising a dual-core and “dual-cover” is made. The dual-core includes an inner core (center) and surrounding outer core layer. The dual-cover includes inner cover and outer cover layers. In yet another construction, a five-piece golf ball having a dual-core, intermediate layer, and dual-cover is made. In still another embodiment, a four piece golf ball comprises a core and a three layer cover.

As used herein, the term, “intermediate layer” means a layer of the ball disposed between the core and cover. The intermediate layer may be considered an outer core layer, or inner cover layer, or any other layer disposed between the inner core and outer cover of the ball. The intermediate layer also may be referred to as a casing or mantle layer. The diameter and thickness of the different layers along with properties such as hardness and compression may vary depending upon the construction and desired playing performance properties of the golf ball and as specified herein.

The core of the golf ball may comprise a polybutadiene rubber material. In one embodiment, the ball contains a single core formed of the polybutadiene rubber composition. In a second embodiment, the ball contains a dual-core comprising an inner core (center) and surrounding outer core layer. In yet another version, the golf ball contains a multi-layered core comprising an inner core, intermediate core layer, and outer core layer.

In general, polybutadiene is a homopolymer of 1,3-butadiene. The double bonds in the 1,3-butadiene monomer are attacked by catalysts to grow the polymer chain and form a polybutadiene polymer having a desired molecular weight. Any suitable catalyst may be used to synthesize the polybutadiene rubber depending upon the desired properties. Normally, a transition metal complex (for example, neodymium, nickel, or cobalt) or an alkyl metal such as alkyllithium is used as a catalyst. Other catalysts include, but are not limited to, aluminum, boron, lithium, titanium, and combinations thereof. The catalysts produce polybutadiene rubbers having different chemical structures. In a cis-bond configuration, the main internal polymer chain of the polybutadiene appears on the same side of the carbon-carbon double bond contained in the polybutadiene. In a trans-bond configuration, the main internal polymer chain is on opposite sides of the internal carbon-carbon double bond in the polybutadiene. The polybutadiene rubber can have various combinations of cis- and trans-bond structures. A preferred polybutadiene rubber has a 1,4 cis-bond content of at least 40%, preferably greater than 80%, and more preferably greater than 90%. In general, polybutadiene rubbers having a high 1,4 cis-bond content have high tensile strength. The polybutadiene rubber may have a relatively high or low Mooney viscosity.

Examples of commercially available polybutadiene rubbers that can be used in accordance with this invention, include, but are not limited to, BR 01 and BR 1220, available from BST Elastomers of Bangkok, Thailand; SE BR 1220LA and SE BR1203, available from DOW Chemical Co of Midland, Mich.; BUDENE 1207, 1207s, 1208, and 1280 available from Goodyear, Inc of Akron, Ohio; BR 01, 51 and 730, available from Japan Synthetic Rubber (JSR) of Tokyo, Japan; BUNA CB 21, CB 22, CB 23, CB 24, CB 25, CB 29 MES, CB 60, CB Nd 60, CB 55 NF, CB 70 B, CB KA 8967, and CB 1221, available from Lanxess Corp. of Pittsburgh. Pa.; BR1208, available from LG Chemical of Seoul, South Korea; UBEPOL BR130B, BR150, BR150B, BR150L, BR230, BR360L, BR710, and VCR617, available from UBE Industries, Ltd. of Tokyo, Japan; EUROPRENE NEOCIS BR 60, INTENE 60 AF and P30AF, and EUROPRENE BR HV80, available from Polimeri Europa of Rome, Italy; AFDENE 50 and NEODENE BR40, BR45, BR50 and BR60, available from Karbochem (PTY) Ltd. of Bruma, South Africa; KBR 01, NdBr 40, NdBR-45, NdBr 60, KBR 710S, KBR 710H, and KBR 750, available from Kumho Petrochemical Co., Ltd. Of Seoul, South Korea; DIENE 55NF, 70AC, and 320 AC, available from Firestone Polymers of Akron, Ohio; and PBR-Nd Group II and Group III, available from Nizhnekamskneftekhim, Inc. of Nizhnekamsk, Tartarstan Republic.

Suitable polybutadiene rubbers for blending with the base rubber may include BUNA® CB22, BUNA® CB23 and BUNA® CB24, BUNA® 1203G1, 1220, 1221, and BUNA® CBNd-40, commercially available from LANXESS Corporation; BSTE BR-1220 available from BST Elastomers Co. LTD; UBEPOL® 360L and UBEPOL® 150L and UBEPOL-BR rubbers, commercially available from UBE Industries, Ltd. of Tokyo, Japan; Budene 1207, 1208 and 1280, commercially available from Goodyear of Akron, Ohio; SE BR-1220, commercially available from Dow Chemical Company; Europrene® NEOCIS® BR 40 and BR 60, commercially available from Polimeri Europa; and BR 01, BR 730, BR 735, BR 11, and BR 51, commercially available from Japan Synthetic Rubber Co., Ltd; and KARBOCHEM® Neodene 40, 45, and 60, commercially available from Karbochem.

The base rubber may further include polyisoprene rubber, natural rubber, ethylene-propylene rubber, ethylene-propylene diene rubber, styrene-butadiene rubber, and combinations of two or more thereof. Another preferred base rubber is polybutadiene optionally mixed with one or more elastomers such as polyisoprene rubber, natural rubber, ethylene propylene rubber, ethylene propylene diene rubber, styrene-butadiene rubber, polystyrene elastomers, polyethylene elastomers, polyurethane elastomers, polyurea elastomers, acrylate rubbers, polyoctenamers, metallocene-catalyzed elastomers, and plastomers. As discussed further below, highly neutralized acid copolymers (HNPs), as known in the art, also can be used to form the core layer as part of the blend. Such compositions will provide increased flexural modulus and toughness thereby improving the golf ball's performance including its impact durability. The base rubber typically is mixed with at least one reactive cross-linking co-agent to enhance the hardness of the rubber composition. Suitable co-agents include, but are not limited to, unsaturated carboxylic acids and unsaturated vinyl compounds. A preferred unsaturated vinyl compound is trimethylolpropane trimethacrylate. The rubber composition is cured using a conventional curing process. Suitable curing processes include, for example, peroxide curing, sulfur curing, high-energy radiation, and combinations thereof. In one embodiment, the base rubber is peroxide cured. Organic peroxides suitable as free-radical initiators include, for example, dicumyl peroxide; n-butyl-4,4-di(t-butylperoxy)valerate; 1,1-di(t-butylperoxy)3,3,5-trimethylcyclohexane; 2,5-dimethyl-2,5-di(t-butylperoxy)hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. Cross-linking agents are used to cross-link at least a portion of the polymer chains in the composition. Suitable cross-linking agents include, for example, metal salts of unsaturated carboxylic acids having from 3 to 8 carbon atoms; unsaturated vinyl compounds and polyfunctional monomers (for example, trimethylolpropane trimethacrylate); phenylene bismaleimide; and combinations thereof. In a particular embodiment, the cross-linking agent is selected from zinc salts of acrylates, diacrylates, methacrylates, and dimethacrylates. In another particular embodiment, the cross-linking agent is zinc diacrylate (“ZDA”). Commercially available zinc diacrylates include those selected from Cray Valley Resource Innovations Inc. Other elastomers known in the art may also be added, such as other polybutadiene rubbers, natural rubber, styrene butadiene rubber, and/or isoprene rubber in order to further modify the properties of the core. When a mixture of elastomers is used, the amounts of other constituents in the core composition are typically based on 100 parts by weight of the total elastomer mixture.

Thermoplastic elastomers (TPE) may also be used to modify the properties of the core layers, or the uncured core layer stock by blending with the uncured rubber. These TPEs include natural or synthetic balata, or high trans-polyisoprene, high trans-polybutadiene, or any styrenic block copolymer, such as styrene ethylene butadiene styrene, styrene-isoprene-styrene, etc., a metallocene or other single-site catalyzed polyolefin such as ethylene-octene, or ethylene-butene, or thermoplastic polyurethanes (TPU), including copolymers, e.g. with silicone. Other suitable TPEs for blending with the thermoset rubbers of the present invention include PEBAX®, which is believed to comprise polyether amide copolymers, HYTREL®, which is believed to comprise polyether ester copolymers, thermoplastic urethane, and KRATON®, which is believed to comprise styrenic block copolymers elastomers. Any of the TPEs or TPUs above may also contain functionality suitable for grafting, including maleic acid or maleic anhydride. Any of the Thermoplastic Vulcanized Rubbers (TPV) such as Santoprene® or Vibram® or ETPV® can be used along with a present invention. In one embodiment, the TPV has a thermoplastic as a continuous phase and a cross-linked rubber particulate as a dispersed (or discontinuous) phase. In another embodiment, the TPV has a cross-linked phase as a continuous phase and a thermoplasttic as a dispersed (or discontinuous) phase to provide reduced loss in elasticity in order to improve the resiliency of the golf ball.

The rubber compositions also may contain “soft and fast” agents such as a halogenated organosulfur, organic disulfide, or inorganic disulfide compounds. Particularly suitable halogenated organosulfur compounds include, but are not limited to, halogenated thiophenols. Preferred organic sulfur compounds include, but not limited to, pentachlorothiophenol (“PCTP”) and a salt of PCTP. A preferred salt of PCTP is ZnPCTP. A suitable PCTP is sold by the Struktol Company (Stow, Ohio) under the tradename, A95. ZnPCTP is commercially available from EchinaChem (San Francisco, Calif.). These compounds also may function as cis-to-trans catalysts to convert some cis bonds in the polybutadiene to trans bonds. Antioxidants also may be added to the rubber compositions to prevent the breakdown of the elastomers. Other ingredients such as accelerators (for example, tetra methylthiuram), processing aids, dyes and pigments, wetting agents, surfactants, plasticizers, as well as other additives known in the art may be added to the rubber composition.

The core may be formed by mixing and forming the rubber composition using conventional techniques. These cores can be used to make finished golf balls by surrounding the core with outer core layer(s), intermediate layer(s), and/or cover materials as discussed further below. In another embodiment, the cores can be formed using highly neutralized polymer (HNP) compositions as disclosed in U.S. Pat. Nos. 6,756,436, 7,030,192, 7,402,629, and 7,517,289. The cores from the highly neutralized polymer compositions can be further cross-linked using any free-radical initiation sources including radiation sources such as gamma or electron beam as well as chemical sources such as peroxides and the like.

A cover of the golf ball of the present invention may comprise surface off-sets, or depressions or projections, on its surface. Surface off-sets include dimples and marking other than dimples. For instance, the surface of the translucent cover may comprise depressed logos, text, lines, arcs, circles or polygons. The surface may also comprise raised projections in the form of logos, text, lines, arcs, circles or polygons. The inclusion of such surface off-sets on the translucent cover creates a unique visual effect, as the juxtaposition of thick and thin portions of the translucent cover material creates a “shadow” effect on the opaque surface below the translucent cover.

The cover of the golf ball of the present invention may have a thickness between 0.02 and 0.1 inch. More preferably, the cover has a thickness between 0.02 and 0.08 inches. Most preferably, the cover has a thickness between 0.025 and 0.07 inches. The thickness of the intermediate layer may be between 0.01 and 0.06 inches. More preferably, the intermediate layer has a thickness between 0.02 and 0.055 inches. Most preferably, the intermediate layer has a thickness between 0.03 and 0.05 inches. The core of the golf ball of the present invention may have a diameter between 0.5 and 1.62 inches. More preferably, the core has a thickness between 0.8 and 1.61 inches. Most preferably, the core has a thickness between 1.0 and 1.6 inches.

A cover of the present invention may be made from thermoplastic and thermoset materials, including for example polyurethane, polyurea, and ionomer resins. In fact, a wide variety of thermoplastic or thermosetting materials can be employed in forming cover layers as well as the core.

Polyurethane that is useful in the present invention includes the reaction product of polyisocyanate, at least one polyol, and at least one curing agent. Any polyisocyanate available to one of ordinary skill in the art is suitable for use according to the invention. Exemplary polyisocyanates include, but are not limited to, 4,4′-diphenylmethane diisocyanate (“MDI”), polymeric MDI, carbodiimide-modified liquid MDI, 4,4′-dicyclohexylmethane diisocyanate (“H₁₂MDI”), p-phenylene diisocyanate (“PPDI”), m-phenylene diisocyanate (“MPDI”), toluene diisocyanate (“TDI”), 3,3′-dimethyl-4,4′-biphenylene diisocyanate (“TODI”), isophoronediisocyanate (“IPDI”), hexamethylene diisocyanate (“HDI”), naphthalene diisocyanate (“NDI”); xylene diisocyanate (“XDI”); p-tetramethylxylene diisocyanate (“p-TMXDI”); m-tetramethylxylene diisocyanate (“m-TMXDI”); ethylene diisocyanate; propylene-1,2-diisocyanate; tetramethylene-1,4-diisocyanate; cyclohexyl diisocyanate; 1,6-hexamethylene-diisocyanate (“HDI”); dodecane-1,12-diisocyanate; cyclobutane-1,3-diisocyanate; cyclohexane-1,3-diisocyanate; cyclohexane-1,4-diisocyanate; 1-isocyanato-3,3,5-trimethyl-5-isocyanatomethylcyclohexane; methyl cyclohexylene diisocyanate; isocyanurate of HDI; triisocyanate of 2,4,4-trimethyl-1,6-hexane diisocyanate (“TMDI”), tetracene diisocyanate, napthalene diisocyanate, anthracene diisocyanate, and mixtures thereof. Polyisocyanates are known to those of ordinary skill in the art as having more than one isocyanate group, e.g., di-, tri-, and tetra-isocyanate. The polyisocyanate may include H₁₂MDI, MDI, PPDI, TDI, or a mixture thereof. It should be understood that, as used herein, the term “MDI” includes 4,4′-diphenylmethane diisocyanate, polymeric MDI, carbodiimide-modified liquid MDI, and mixtures thereof and, additionally, that the diisocyanate employed may be “low free monomer,” understood by one of ordinary skill in the art to have lower levels of “free” isocyanate monomer, typically less than about 0.1 percent to about 0.5 percent free monomer. Examples of “low free monomer” diisocyanates include, but are not limited to Low Free Monomer MDI, Low Free Monomer TDI, Low Free MPDI, and Low Free Monomer PPDI.

The at least one polyisocyanate should have less than about 14 percent unreacted NCO groups. Preferably, the at least one polyisocyanate has less than about 7.9 percent NCO, more preferably, between about 2.5 percent and about 7.8 percent, and most preferably, between about 4 percent to about 6.5 percent. In an alternative embodiment, the at least one polyisocynanate could have more than about 14 percent unreacted NCO groups, which would be suitable if the golf balls are made by means of reaction injection molding (RIM).

As used herein, the term “percent NCO” or “% NCO” refers to the percent by weight of free, reactive, and unreacted isocyanate functional groups in an isocyanate-functional molecule or material. The total formula weight of all the NCO groups in the molecule or material, divided by its total molecular weight, and multiplied by 100, equals the percent NCO.

Any polyol available to one of ordinary skill in the art is suitable for use according to the invention. Exemplary polyols include, but are not limited to, polyether polyols, hydroxy-terminated polybutadiene and partially/fully hydrogenated derivatives, polyester polyols, polycaprolactone polyols, and polycarbonate polyols. In one preferred embodiment, the polyol includes polyether polyol, more preferably those polyols that have the generic structure:

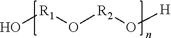

where R₁ and R₂ are straight or branched hydrocarbon chains, each containing from 1 to about 20 carbon atoms, and n ranges from 1 to about 45. Examples include, but are not limited to, polytetramethylene ether glycol, polyethylene propylene glycol, polyoxypropylene glycol, and mixtures thereof. The hydrocarbon chain can have saturated or unsaturated bonds and substituted or unsubstituted aromatic and cyclic groups. Preferably, the polyol of the present invention includes PTMEG.

In another embodiment, polyester polyols are included in the polyurethane material of the invention. Preferred polyester polyols have the generic structure:

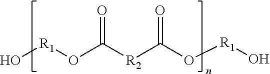

where R₁ and R₂ are straight or branched hydrocarbon chains, each containing from 1 to about 20 carbon atoms, and n ranges from 1 to about 25. Suitable polyester polyols include, but are not limited to, polyethylene adipate glycol, polybutylene adipate glycol, polyethylene propylene adipate glycol, ortho-phthalate-1,6-hexanediol, and mixtures thereof. The hydrocarbon chain can have saturated or unsaturated bonds, or substituted or unsubstituted aromatic and cyclic groups.

In another embodiment, polycaprolactone polyols are included in the materials of the invention.

Preferably, any polycaprolactone polyols have the generic structure:

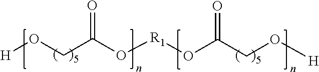

where R₁ is a straight chain or branched hydrocarbon chain containing from 1 to about 20 carbon atoms, and n is the chain length and ranges from 1 to about 20. Suitable polycaprolactone polyols include, but are not limited to, 1,6-hexanediol-initiated polycaprolactone, diethylene glycol initiated polycaprolactone, trimethylol propane initiated polycaprolactone, neopentyl glycol initiated polycaprolactone, 1,4-butanediol-initiated polycaprolactone, and mixtures thereof. The hydrocarbon chain can have saturated or unsaturated bonds, or substituted or unsubstituted aromatic and cyclic groups.

In yet another embodiment, the polycarbonate polyols are included in the polyurethane material of the invention. Preferably, any polycarbonate polyols have the generic structure:

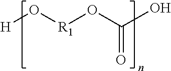

where R₁ is predominantly bisphenol A units -(p-C₆H₄)—C(CH₃)₂-(p-C₆H₄)— or derivatives thereof, and n is the chain length and ranges from 1 to about 20. Suitable polycarbonates include, but are not limited to, polyphthalate carbonate. The hydrocarbon chain can have saturated or unsaturated bonds, or substituted or unsubstituted aromatic and cyclic groups. In one embodiment, the molecular weight of the polyol is from about 200 to about 4000.

Polyamine curatives are also suitable for use in the polyurethane composition of the invention and have been found to improve cut, shear, and impact resistance of the resultant balls. Preferred polyamine curatives have the general formula:

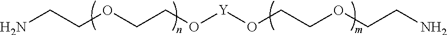

where n and m each separately have values of 0, 1, 2, or 3, and where Y is ortho-cyclohexyl, meta-cyclohexyl, para-cyclohexyl, ortho-phenylene, meta-phenylene, or para-phenylene, or a combination thereof. Preferred polyamine curatives include, but are not limited to, 3,5-dimethylthio-2,4-toluenediamine and isomers thereof (trade name ETHACURE 100 and/or ETHACURE 100 LC); 3,5-diethyltoluene-2,4-diamine and isomers thereof, such as 3,5-diethyltoluene-2,6-diamine; 4,4′-bis-(sec-butylamino)-diphenylmethane; 1,4-bis-(sec-butylamino)-benzene, 4,4′-methylene-bis-(2-chloroaniline); 4,4′-methylene-bis-(3-chloro-2,6-diethylaniline); trimethylene glycol-di-p-aminobenzoate; polytetramethyleneoxide-di-p-aminobenzoate; N,N′-dialkyldiamino diphenyl methane; para, para′-methylene dianiline (MDA), m-phenylenediamine (MPDA), 4,4′-methylene-bis-(2-chloroaniline) (MOCA), 4,4′-methylene-bis-(2,6-diethylaniline), 4,4′-diamino-3,3′-diethyl-5,5′-dimethyl diphenylmethane, 2,2′, 3,3′-tetrachloro diamino diphenylmethane, 4,4′-methylene-bis-(3-chloro-2,6-diethylaniline), (LONZACURE M-CDEA), trimethylene glycol di-p-aminobenzoate (VERSALINK 740M), and mixtures thereof. Preferably, the curing agent of the present invention includes 3,5-dimethylthio-2,4-toluenediamine and isomers thereof, such as ETHACURE 300, commercially available from Albermarle Corporation of Baton Rouge, La. Suitable polyamine curatives, which include both primary and secondary amines, preferably have molecular weights ranging from about 64 to about 2000. Preferably, n and m, each separately, have values of 1, 2, or 3, and preferably, 1 or 2.

At least one of a diol, triol, tetraol, hydroxy-terminated, may be added to the aforementioned polyurethane composition. Suitable hydroxy-terminated curatives have the following general chemical structure:

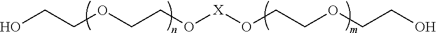

where n and m each separately have values of 0, 1, 2, or 3, and where X is ortho-phenylene, meta-phenylene, para-phenylene, ortho-cyclohexyl, meta-cyclohexyl, or para-cyclohexyl, or mixtures thereof. Preferably, n and m, each separately, have values of 1, 2, or 3, and more preferably, 1 or 2.

Preferred hydroxy-terminated curatives for use in the present invention include at least one of 1,3-bis(2-hydroxyethoxy)benzene and 1,3-bis-[2-(2-hydroxyethoxy)ethoxy]benzene, and 1,3-bis-{2-[2-(2-hydroxyethoxy)ethoxy]ethoxy}benzene; 1,4-butanediol; resorcinol-di-(β-hydroxyethyl)ether; and hydroquinone-di-(β-hydroxyethyl)ether; and mixtures thereof. Preferably, the hydroxy-terminated curatives have molecular weights ranging from about 48 to 2000. It should be understood that molecular weight, as used herein, is the absolute weight average molecular weight and would be understood as such by one of ordinary skill in the art. Both the hydroxy-terminated and amine curatives can include one or more saturated, unsaturated, aromatic, and cyclic groups. Additionally, the hydroxy-terminated and amine curatives can include one or more halogen groups. Suitable diol, triol, and tetraol groups include ethylene glycol, diethylene glycol, polyethylene glycol, propylene glycol, polypropylene glycol, lower molecular weight polytetramethylene ether glycol, and mixtures thereof. The polyurethane composition can be formed with a blend or mixture of curing agents. If desired, however, the polyurethane composition may be formed with a single curing agent.

The cover may alternatively comprise polyurea. In one embodiment, the polyurea prepolymer includes at least one diisocyanate and at least one polyether amine.

In this aspect of the invention the diisocyanate is preferably saturated, and can be selected from the group consisting of ethylene diisocyanate; propylene-1,2-diisocyanate; tetramethylene diisocyanate; tetramethylene-1,4-diisocyanate; 1,6-hexamethylene-diisocyanate; octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; methyl-cyclohexylene diisocyanate; 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophoronediisocyanate; triisocyanate of HDI; triisocyanate of 2,2,4-trimethyl-1,6-hexane diisocyanate; 4,4′-dicyclohexylmethane diisocyanate; 2,4-hexahydrotoluene diisocyanate; 2,6-hexahydrotoluene diisocyanate; and mixtures thereof. The saturated diisocyanate is preferably selected from the group consisting of isophoronediisocyanate, 4,4′-dicyclohexylmethane diisocyanate, 1,6-hexamethylene diisocyanate, or a combination thereof.

In another embodiment, the diisocyanate is an aromatic aliphatic isocyanate selected from the group consisting of meta-tetramethylxylene diisocyanate; para-tetramethylxylene diisocyanate; trimerized isocyanurate of polyisocyanate; dimerized uredione of polyisocyanate; modified polyisocyanate; and mixtures thereof.

The polyether amine may be selected from the group consisting of polytetramethylene ether diamines, polyoxypropylene diamines, poly(ethylene oxide capped oxypropylene) ether diamines, triethyleneglycoldiamines, propylene oxide-based triamines, trimethylolpropane-based triamines, glycerin-based triamines, and mixtures thereof. In one embodiment, the polyether amine has a molecular weight of about 1000 to about 3000.

The curing agent may be selected from the group consisting of hydroxy-terminated curing agents, amine-terminated curing agents, and mixtures thereof, and preferably has a molecular weight from about 250 to about 4000.

In one embodiment, the hydroxy-terminated curing agents are selected from the group consisting of ethylene glycol; diethylene glycol; polyethylene glycol; propylene glycol; 2-methyl-1,3-propanediol; 2-methyl-1,4-butanediol; dipropylene glycol; polypropylene glycol; 1,2-butanediol; 1,3-butanediol; 1,4-butanediol; 2,3-butanediol; 2,3-dimethyl-2,3-butanediol; trimethylolpropane; cyclohexyldimethylol; triisopropanolamine; tetra-(2-hydroxypropyl)-ethylene diamine; diethylene glycol di-(aminopropyl) ether; 1,5-pentanediol; 1,6-hexanediol; 1,3-bis-(2-hydroxyethoxy) cyclohexane; 1,4-cyclohexyldimethylol; 1,3-bis-[2-(2-hydroxyethoxy)ethoxy]cyclohexane; 1,3-bis-{2-[2-(2-hydroxyethoxy)ethoxy]ethoxy}cyclohexane; trimethylolpropane; polytetramethylene ether glycol, preferably having a molecular weight from about 250 to about 3900; and mixtures thereof.

The amine-terminated curing agents may be selected from the group consisting of ethylene diamine; hexamethylene diamine; 1-methyl-2,6-cyclohexyl diamine; tetrahydroxypropylene ethylene diamine; 2,2,4- and 2,4,4-trimethyl-1,6-hexanediamine; 4,4′-bis-(sec-butylamino)-dicyclohexylmethane; 1,4-bis-(sec-butylamino)-cyclohexane; 1,2-bis-(sec-butylamino)-cyclohexane; derivatives of 4,4′-bis-(sec-butylamino)-dicyclohexylmethane; 4,4′-dicyclohexylmethane diamine; 1,4-cyclohexane-bis-(methylamine); 1,3-cyclohexane-bis-(methylamine); diethylene glycol di-(aminopropyl) ether; 2-methylpentamethylene-diamine; diaminocyclohexane; diethylene triamine; triethylene tetramine; tetraethylene pentamine; propylene diamine; 1,3-diaminopropane; dimethylamino propylamine; diethylamino propylamine; imido-bis-propylamine; monoethanolamine, diethanolamine; triethanolamine; monoisopropanolamine, diisopropanolamine; isophoronediamine; and mixtures thereof.

In one embodiment, the composition further includes a catalyst that can be selected from the group consisting of a bismuth catalyst, zinc octoate, di-butyltin dilaurate, di-butyltin diacetate, tin (II) chloride, tin (IV) chloride, di-butyltin dimethoxide, dimethyl-bis[1-oxonedecyl)oxy]stannane, di-n-octyltin bis-isooctyl mercaptoacetate, triethylenediamine, triethylamine, tributylamine, oleic acid, acetic acid; delayed catalysts, and mixtures thereof. The catalyst may be present from about 0.005 percent to about 1 percent by weight of the composition.

Any method available to one of ordinary skill in the art may be used to combine the polyisocyanate, polyol or polyamine, and curing agent of the present invention. One commonly employed method, known in the art as a one-shot method, involves concurrent mixing of the polyisocyanate, polyol or polyether amine, and curing agent. This method results in a mixture that is inhomogenous (more random) and affords the manufacturer less control over the molecular structure of the resultant composition. A preferred method of mixing is known as the prepolymer method. In this method, the polyisocyanate and the polyol or polyether amine are mixed separately prior to addition of the curing agent. This method seems to afford a more homogeneous mixture resulting in a more consistent polymer composition.

As mentioned above, the cover layer may also comprise ionomeric materials, such as ionic copolymers of ethylene and an unsaturated monocarboxylic acid, which are available under the trademark SURLYN® of E.I. DuPont de Nemours & Co., of Wilmington, Del., or IOTEK® or ESCOR® of Exxon. These are copolymers or terpolymers of ethylene and methacrylic acid or acrylic acid totally or partially neutralized, i.e., from about 1 to about 100 percent, with salts of zinc, sodium, lithium, magnesium, potassium, calcium, manganese, nickel or the like. In one embodiment, the carboxylic acid groups are neutralized from about 10 percent to about 100 percent. The carboxylic acid groups may also include methacrylic, crotonic, maleic, fumaric or itaconic acid. The salts are the reaction product of an olefin having from 2 to 10 carbon atoms and an unsaturated monocarboxylic acid having 3 to 8 carbon atoms.

The cover layer may also include at least one ionomer, such as acid-containing ethylene copolymer ionomers, including E/X/Y terpolymers where E is ethylene, X is an acrylate or methacrylate-based softening comonomer present in about 0 to 50 weight percent and Y is acrylic or methacrylic acid present in about 5 to 35 weight percent. The ionomer may include so-called “low acid” and “high acid” ionomers, as well as blends thereof. In general, ionic copolymers including up to about 15 percent acid are considered “low acid” ionomers, while those including greater than about 15 percent acid are considered “high acid” ionomers. “Low acid” ionomers may be combined with a softening comonomer such as vinyl esters of aliphatic carboxylic acids wherein the acids have 2 to 10 carbon atoms, vinyl ethers wherein the alkyl groups contains 1 to 10 carbon atoms, and alkyl acrylates or methacrylates wherein the alkyl group contains 1 to 10 carbon atoms. Suitable softening comonomers include vinyl acetate, methyl acrylate, methyl methacrylate, ethyl acrylate, ethyl methacrylate, butyl acrylate, and butyl methacrylate, and are believed to impart high spin to golf balls.

Covers comprising “high acid” ionomers are believed to impart low spin and longer distance to golf balls. A cover of the present invention may comprise about 15 to about 35 weight percent acrylic or methacrylic acid, making the ionomer a high modulus ionomer. An additional comonomer such as an acrylate ester (i.e., iso- or n-butylacrylate, etc.) can also be included to produce a softer terpolymer. The additional comonomer may be selected from the group consisting of vinyl esters of aliphatic carboxylic acids wherein the acids have 2 to 10 carbon atoms, vinyl ethers wherein the alkyl groups contains 1 to 10 carbon atoms, and alkyl acrylates or methacrylates wherein the alkyl group contains 1 to 10 carbon atoms. Suitable softening comonomers include vinyl acetate, methyl acrylate, methyl methacrylate, ethyl acrylate, ethyl methacrylate, butyl acrylate, butyl methacrylate, or the like.

The core of the present invention may comprise a polymer such as ionomeric copolymers and terpolymers, thermoset materials, ionomer precursors, thermoplastics, thermoplastic elastomers, polybutadiene rubber, balata, grafted metallocene-catalyzed polymers, single-site polymers, high-crystalline acid polymers, cationic ionomers, and mixtures thereof. The core may be colored or may be transparent or translucent. As used herein, and as discussed in commonly-owned U.S. Patent Publication No. 2007/0149323, previously incorporated by reference, the team “core” refers to any portion of the golf ball surrounded by the cover.

In the case of a golf ball comprising three layers, the core is the portion including at least the inner-most center layer and the intermediate layer, also referred to as the outer core layer, immediately surrounding the center.

In accordance with the present invention, the intermediate or outer core layer may comprise a solid polymeric material or may be a layer of wound elastomeric material. An intermediate or outer core layer comprising a solid polymeric material may be colored or may be transparent or translucent.

A golf ball having a core comprising two layers may be referred to as a “dual core” or a “multi-piece core.” A golf ball of the present invention may also comprise a multi-piece core having more than two layers. The center of a dual core or multi-piece core may comprise a solid material or a fluid, i.e., a gas or liquid. The center may alternatively comprise a semi-solid such as a paste or gel.

The golf ball may also contain additives, ingredients, and other materials in amounts that do not detract from the properties of the final composition. These additive materials include, but are not limited to, activators such as calcium or magnesium oxide; fatty acids such as stearic acid and salts thereof; fillers and reinforcing agents such as organic or inorganic particles, for example, clays, talc, calcium, magnesium carbonate, silica, aluminum silicates, zeolites, powdered metals, and organic or inorganic fibers, plasticizers such as dialkyl esters of dicarboxylic acids; surfactants; softeners; tackifiers; waxes; ultraviolet (UV) light absorbers and stabilizers; antioxidants; optical brighteners; whitening agents such as titanium dioxide and zinc oxide; dyes and pigments; processing aids; release agents; and wetting agents. These compositions provide improved melt processability, and a balance of ball performance.

Blowing/foaming agents may also be particularly compatible with the golf ball produced by the process of the invention, including, for example those disclosed in U.S. Pat. No. 7,708,654. Typical physical foaming/blowing agents include volatile liquids such as freons (CFCs), other halogenated hydrocarbons, water, aliphatic hydrocarbons, gases, and solid blowing agents, i.e., compounds that liberate gas as a result of desorption of gas. Preferably, the blowing agent includes an adsorbent. Typical adsorbents include, for example, activated carbon, calcium carbonate, diatomaceous earth, and silicates saturated with carbon dioxide.

Chemical foaming/blowing agents may be incorporated. Chemical blowing agents may be inorganic, such as ammonium carbonate and carbonates of alkalai metals, or may be organic, such as azo and diazo compounds, such as nitrogen-based azo compounds. Suitable azo compounds include, but are not limited to, 2,2′-azobis(2-cyanobutane), 2,2′-azobis(methylbutyronitrile), azodicarbonamide, p,p′-oxybis(benzene sulfonyl hydrazide), p-toluene sulfonyl semicarbazide, p-toluene sulfonyl hydrazide. Other blowing agents include any of the Celogens®, sold by Crompton Chemical Corporation, and nitroso compounds, sulfonylhydrazides, azides of organic acids and their analogs, triazines, tri- and tetrazole derivatives, sulfonyl semicarbazides, urea derivatives, guanidine derivatives, and esters such as alkoxyboroxines. Other possible blowing agents include agents that liberate gasses as a result of chemical interaction between components such as mixtures of acids and metals, mixtures of organic acids and inorganic carbonates, mixtures of nitriles and ammonium salts, and the hydrolytic decomposition of urea.

Alternatively, low specific gravity can be achieved by incorporating low density fillers or agents such as hollow fillers or microspheres in the polymeric matrix, where the cured composition has the preferred specific gravity. Moreover, the polymeric matrix can be foamed to decrease its specific gravity, microballoons, or other low density fillers as described in U.S. Pat. No. 6,692,380 (“'380 Patent”). The '380 patent is incorporated by reference in its entirety.

A “clear” or “transparent” cover preferably has an average transmittance of visible light (e.g., between about 380 nm and about 770 nm or alternately between about 400 nm and about 700 nm) of at least about 40 percent, preferably at least about 60 percent, more preferably at least about 80 percent. The average transmittance referred to herein is typically measured for incident light normal (i.e., at approximately 90°) to the plane of the object and can be measured using any known light transmission apparatus and method, e.g., a UV-Vis spectrophotometer. A golf ball of the invention may comprise covers that are either entirely or partially clear or transparent as well.

A “translucent” cover preferably has an average transmittance of visible light (e.g., between about 380 nm and about 770 nm or alternately between about 400 nm and about 700 nm) of at least about 10 percent, preferably at least about 20 percent, more preferably at least about 30 percent. A golf ball of the invention may comprise covers that are either entirely or partially translucent as well.

In one embodiment, the transparent or translucent cover comprises a plurality of dimples on its surface as well as surface off-sets other than dimples. The surface off-sets may be artifacts from the casting or molding of the cover. For example, during injection molding, a golf ball core or precursor is placed within a molding cavity comprising two hemispheres. The core or precursor is supported by pins so that it maintains its position in the center of the golf ball. Molten cover material is then injected into the molding cavity through apertures or gates and surrounds the core or precursor to harden and form the cover. As the molten cover material envelops the core or precursor, the supporting pins retract, allowing the molten material to fill in the cavities created by the pins. The retraction of the pins often causes the formation of “witness lines” on the cover about the area where the pins meet the mold. Likewise, during compression molding of a cover, a parting line may form along the equator of the golf ball. In accordance with the present invention, the witness lines created on the cover by the injection molding process or the parting line resulting from compression molding may be maintained on the clear or translucent cover to create unique visual effects, such as the enhancement of shadows on the core of the ball.

In other embodiments, these artifacts from the manufacturing process may be removed by post-mold finishing processes such as vibration tumbling.

Other non-limiting examples of surface off-sets include a molded stripe, which can be co-molded to provide the stripe with a color different than the core or the intermediate layer, so that the ball may identified as a practice ball; a molded line to aid in putting alignment; logos or indicia; raised text or indicia; great circles; lines or line segments; polygons or other shapes; arcs or curves; or text. The molded elements described above may be depressed into the cover or may rise as projections away from the surface of the cover.

The surface of the golf ball may also include optically active sites detectable by a ball-launching mechanism to allow for launch monitor testing. The sites may be reflective in the visible or invisible range.

In another embodiment of the current invention, the cover may be cast or compression molded. This process involves the joining of two cover hemispheres at an equator. Additionally, other inventive aspects of the present invention, such as a cover comprising a transparent or translucent material and having an amount of pigment or dye or an amount of reflective particulates, may be incorporated into only one hemisphere of the golf ball cover.

Dye or pigment may be added to the cover material to create a golf ball having a translucent colored cover. In the case of a golf ball with depressions molded into the cover, the addition of dye to the clear cover material can help to enhance the shadow effect of the depressions incorporated on the surface of the cover. The dye may be a fluorescent dye.

In one aspect of the present invention, dyes or pigments may be added to any or all layers of the golf ball including, but not limited to, the cover and the core, the intermediate layer and any coating as well. The dyes or pigments may be inorganic or organic. In one embodiment, the pigments include effect pigments.

According to another embodiment, the cover may comprise reflective particulates to create the effect of sparkle, glitter, pearlescence or iridescence. The cover may contain reflective or optically active particulates such as described by Murphy in U.S. Pat. No. 5,427,378 which is incorporated herein by reference. Pearlescent pigments sold by the Mearle Corporation can also be used in this way. The reflective material may comprise at least one member selected from the group consisting of metal flake, iridescent glitter, metalized film and colored polyester foil.

In one embodiment of the present invention, the core may comprise a swirled color pattern achieved by mixing materials of different colors or different color shades during the manufacture of the core. The swirled pattern of the core can be created using the method described in U.S. Pat. No. 2,283,845, which is incorporated herein by reference in its entirety.

In a variation of the above embodiment, the core may be a multi-piece core having a center and an outer core layer visible through the transparent or translucent cover. Preferably, the outer core layer has a swirled appearance. The outer swirled core layer may comprise molded rubber or thermoplastic halves having a swirled pattern. The center of the multi-piece core may comprise rubber or a blend thereof, rubber regrind, filler, foam, liquid, or other suitable materials.

In another embodiment of the present invention, the core may be formed from a slug or prep or perform made from multiple segments of differently color shaded material. The slug may comprise at least three differently color shaded segments, and each color shade segment accounts for at least five percent of the total color coverage of the golf ball. The multi-color shaded slug is molded to form a multi-colored core.

The core may include a plurality of surface off-sets including ridges, raised edges, points or other projections on its outer surface. The clear or translucent cover is molded around the core by casting, injection molding, compression molding or other methods. The projections on the outer surface of the core provide more surface area for the adherence of the cover, decreasing the possibility of the separation or delamination of the cover from the core. The surface of the core may also include a plurality of depressions or valleys, also increasing surface area and so providing for better adhesion of the cover. The resulting ball is more durable than golf balls comprising smooth cores.

A golf ball of the present invention may alternatively comprise a clear or translucent cover, a core and an intermediate layer including a plurality of surface off-sets including ridges, raised edges, points or other projections on its outer surface. The clear or translucent cover is molded around the intermediate layer by casting, injection molding, compression molding or other methods. As in the above embodiment, the projections on the outer surface of the intermediate layer provide more surface area for the adherence of the cover, decreasing the possibility of the separation or delamination of the cover and core.

The transparent or translucent cover of the present invention may additionally act as a lens, magnifying the appearance of the core or intermediate layer below. Any text, logo or design printed on the core or intermediate layer will then also be magnified. More particularly, the transparent or translucent cover comprises a polymeric material having a magnification factor from about 2× to about 5× to make text or other markings printed on the surface of the layer immediately beneath the cover appear larger than its actual size. The actual size of any text or markings is typically small given the limited amount of space on the surface of the golf ball layer. Because a player may not be able to easily discern the fine text or marking, it is advantageous to magnify the physical appearance of the indicia. The magnified appearance of the core or intermediate layer or any marking on the surface of the core or intermediate layer may also enhance a player's ability to visualize the ball, and hence may improve a player's ability to strike the ball in the desired location.

The golf balls of the present invention may be painted, coated, or surface treated for further benefits. For example, trademarks or other indicia may be printed, i.e., pad-printed, transfer printed, decal or ink jet printed, on the inner layer such that they are visible through the translucent cover. Protective and decorative coating materials, as well as methods of applying such materials to the surface of a golf ball cover, are well known in the golf ball art. Generally, such coating materials comprise urethanes, urethane hybrids, epoxies, polyesters and acrylics. If desired, more than one coating layer can be used. Further discussion of finishing treatments may be found in parent application Ser. No. 11/707,493, which was previously incorporated by reference in its entirety.

Table I below illustrates several non-limiting embodiments of the invention. Specifically, Table I displays the construction and overall golf ball CIECAM color appearance model color characteristics for five prophetic golf balls GB I-GBV. GB I is a 1 piece golf ball wherein the core contributes a pink pigment to the overall golf ball color and the coating contributes a pink tint to the overall golf ball forming a golf ball having an overall golf ball pink color defined by the CIECAM Color Model characteristics a=72, b=13, h=10°, J=44 and C=73. GB II is a coated 2 piece golf ball wherein the core contributes a pink pigment to the overall golf ball color, the cover contributes a pink dye to the overall golf ball color, and the coating contributes a pink tint to the overall golf ball forming a golf ball having an overall golf ball pink color defined by the CIECAM Color Model characteristics a=74, b=16. h=12°, J=35, and C=76. GB III is a 2 piece golf ball wherein the core contributes a purple pigment to the overall golf ball color and the cover is translucent, forming a golf ball having an overall golf ball purple color defined by the CIECAM Color Model characteristics a=33, b=−32. h=316°, J=46, and C=47. GB IV is a 3 piece golf ball wherein the core is opaque, the intermediate layer contributes a purple pigment to the overall golf ball color and the cover is transparent to form a golf ball having an overall purple golf ball color defined by the CIECAM Color Model characteristics a=39, b=−21. h=331°, J=31, and C=44. Finally, GB V is a 3 piece golf ball wherein the core is opaque, the intermediate layer contributes a purple pigment to the overall golf ball color and the cover is pearlescent with a purple tinted coating to form a golf ball having an overall purple golf ball color defined by the CIECAM Color Model characteristics a=52, b=−26. h=334°, J=50, and C=58.

While the examples in Table I include pink or purple pigments, dyes or tints, the present invention contemplates that any color may be used in any of the core, intermediate layer, cover or a coating which will combine within the golf ball construction to create an over golf ball color within the CIECAM Color Model characteristic ranges disclosed herein and that many different colors may be simultaneously discernable by the human eye due to the color effects incorporated in the golf ball of the invention. By non-limiting example, it is envisioned that a blue may be combined with a red which creates an over all golf ball color of purple within the CIECAM Color Model characteristic ranges disclosed herein. Meanwhile, the same golf ball may also have an appearance of several other different colors due to the interplay of the color effects in the golf ball with visible light.

TABLE I
OVERALL GOLF BALL CIECAM COLOR CHARACTERISTICS
FOR FIVE GOLF BALL CONSTRUCTIONS

| | Golf Ball Construction & | | | | |
|---|---|---|---|---|---|
| | Overall GB CIECAM Color | | | | |
| | Characteristcs | | | | |
| | | GB II | | | GB V |
| | | Pink | | GB IV | Purple |
| | GB I | Coated | GB III | Purple | Coated |
| | Pink 1 | 2 piece | Purple | Multi-layer | Multilayer |
| | Piece | GB | 2 Piece GB | GB | GB |
| Core | Pink | Pink | Purple | Opaque | Opaque |
| | pigment | pigment | pigment | | |
| Inter- | N/A | N/A | N/A | Purple | Purple |
| mediate | | | | pigment | pigment |
| Layer | | | | | |
| Cover | N/A | Pink dye | Translucent | Transparent | Pearlescent |
| Coating | Pink | Pink tint | N/A | N/A | Purple Tint |
| | tint | | | | |
| a | 72 | 74 | 33 | 39 | 52 |
| b | 13 | 16 | −32 | −21 | −26 |
| h° | 10 | 12 | 316 | 331 | 334 |
| J | 44 | 35 | 46 | 31 | 50 |
| C | 73 | 76 | 47 | 44 | 58 |

Unless otherwise expressly specified, all of the numerical ranges, amounts, values and percentages such as those for amounts of materials, and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used.

While it is apparent that the illustrative embodiments of the invention disclosed herein fulfill the preferred embodiments of the present invention, it is appreciated that numerous modifications and other embodiments may be devised by those skilled in the art. Examples of such modifications include reasonable variations of the numerical values and/or materials and/or components discussed above. Hence, the numerical values stated above and claimed below specifically include those values and the values that are approximate to those stated and claimed values. Therefore, it will be understood that the appended claims are intended to cover all such modifications and embodiments, which would come within the spirit and scope of the present invention.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. For example, the compositions of the present invention may be used in a variety of equipment. Such modifications are also intended to fall within the scope of the appended claims.

While any of the embodiments herein may have any known dimple number and pattern, a preferred number of dimples is 252 to 456, and more preferably is 328 to 392. The dimples may comprise any width, depth, and edge angle and patterns which satisfy the relationships defined between cover layers as disclosed herein. The parting line configuration of said pattern may be either a straight line or a staggered wave parting line (SWPL). In one embodiment, the golf ball has 328, 330, 332, or 392 dimples, comprises 5 to 7 dimples sizes, and the parting line is a SWPL.

In any of these embodiments the single-layer core may be replaced with a two or more layer core wherein at least one core layer has a negative hardness gradient. Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range.

Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

What is claimed is:

1. A method of making a golf ball comprising:
providing a core, a cover layer and optionally an intermediate layer, wherein at least one of the core, cover layer and intermediate layer comprises or is surface-coated with a color effect providing pigment comprising at least one of: (1) calcium aluminum borosilicate coated with a metal oxide; (2) silicon dioxide platelets coated with metal oxide; and (3) an iron oxide pigment substrate coated with a metal oxide;
optionally forming the intermediate layer about the core; and
forming the cover about the intermediate layer or the core to complete the golf ball.

2. The method of making a golf ball of claim 1, wherein the color effect providing pigment has a particle size of from about 5 μm to about 200 μm.

3. The method of making a golf ball of claim 1, wherein the color effect providing pigment has a particle size of from about 10 μm to about 100 μm.

4. The method of making a golf ball of claim 1, wherein the color effect providing pigment has a particle size of from about 5 μm to about 50 μm.

5. The method of making a golf ball of claim 1, wherein the color effect providing pigment has a particle size of from about 15 μm to about 20 μm.

6. The method of making a golf ball of claim 1, wherein the layer comprising the color effect providing pigment further comprises at least one of a thermoplastic material, a thermoset material, an ionomer material and a highly neutralized polymer material.

7. The method of making a golf ball of claim 1, wherein the layer comprising the color effect providing pigment has a Mooney viscosity of from about 30 to about 130.

8. The method of making a golf ball of claim 1, wherein the layer comprising the color effect providing pigment has a moisture vapor transmission rate of about 0.95 grams·mm/m²·day or greater.

9. The method of making a golf ball of claim 1, wherein at least one color of the golf ball as seen by the human eye has a J lightness value expressed in the CIE CIECAM color system and a C chroma value expressed in the CIE CIECAM color system.

10. The method of making a golf ball of claim 1, wherein at least one color for the golf ball of the golf ball as seen by the human eye has an a* and b* value expressed within the CIE LAB color model.

11. The method of making a golf ball of claim 1, wherein the cover comprises a material selected from the group comprising polyurethanes, polyureas, and ionomer resins.

12. The method of making a golf ball of claim 1, wherein the color effect providing pigment further comprises at least one of a pigment, a dye and a tint.

13. The method of making a golf ball of claim 12, wherein at least one of the pigment, dye and tint is fluorescent.

14. The method of making a golf ball of claim 12, wherein at least one of the pigment, dye and tint is inorganic.

15. The method of making a golf ball of claim 12, wherein at least one of the pigment, dye and tint is organic.

16. The method of making a golf ball of claim 1, wherein the cover further comprises particulate material selected from the group comprising metal flake, iridescent glitter, metalized film and colored polyester foil.

17. The method of making a golf ball of claim 1, wherein at least one layer of the cover comprises a material which is at least partially transparent, translucent or pearlescent.

18. The method of making a golf ball of claim 1, wherein the cover and the intermediate layer comprise a material which is at least partially transparent, translucent or pearlescent.

19. A method of making a golf ball comprising:
providing a core of at least one layer,
providing a cover comprising an inner cover layer that either comprises or is surface coated and an outer cover layer;
optionally providing at least one intermediate layer,
wherein the inner cover layer either comprises or is surface coated with an effect or luster pigment which contributes to the color appearance of the ball and the outer cover layer is at least partially transparent,
said effect or luster pigment comprising at least one of: (1) calcium aluminum borosilicate coated with a metal oxide; (2) silicon dioxide platelets coated with metal oxide; and (3) an iron oxide pigment substrate coated with a metal oxide;
forming the inner cover layer about the core; and
forming the outer cover layer about the inner cover layer to complete the golf ball.

20. The method of making a golf ball of claim 19, wherein the color effect providing pigment has a particle size of from about 5 μm to about 200 μm.

21. The method of making a golf ball of claim 19, wherein the color effect providing pigment further comprises at least one of a pigment, a dye and a tint.

22. The method of making a golf ball of claim 21, wherein at least one of the pigment, dye and tint is fluorescent.

23. A method of making a golf ball comprising:
providing a core and a cover
forming the cover about the core;
forming a marked surface portion in an outer surface of the cover either before or after the step of forming the cover about the core,
the marked surface portion comprising a pigment or ink comprising at least one of: (1) calcium aluminum borosilicate coated with a metal oxide; (2) silicon dioxide platelets coated with metal oxide; and (3) an iron oxide pigment substrate coated with a metal oxide,
such that said marked surface portion appears as a different color to the human eye than an unmarked portion of the cover outer surface.

24. The method of making a golf ball of claim 23, wherein the color effect providing pigment has a particle size of from about 5 μm to about 200 μm.

25. The method of making a golf ball of claim 23, wherein the color effect providing pigment further comprises at least one of a pigment, a dye and a tint.
